(19) United States
(12) Patent Application Publication
(10) Pub. No.: US 2016/0185000 A1
(43) Pub. Date: Jun. 30, 2016

(54) Snips with One-Hand-Operable Lock Device

(71) Applicant: ALLPROFESSIONAL MFG.CO., LTD, Taichung (TW)

(72) Inventor: Chung-Ping Huang, Taichung (TW)

(21) Appl. No.: 14/622,972

(22) Filed: Feb. 16, 2015

(30) Foreign Application Priority Data
Dec. 27, 2014 (TW) 103145893

(51) Int. Cl. B26B 13/16

(52) U.S. Cl. CPC B26B 13/16

(57) ABSTRACT

A pair of snips with one-hand-operable lock device includes a first and second grip disposed side by side, a pair of cutting members pivotally connecting with each other and including one cutting member connecting to the first grip and the other cutting member connecting to the second grip respectively, and a lock device including a structural member pivotally connecting to the first grip and including a first structural section as a user control end disposed at one of two opposite ends of the structural member, a second structural section as a locking end disposed at the other end of the structural member, and a third structural section disposed between the first and second structural sections and including a pivot extending therefrom and engaging with the first grip.

### BACKGROUND OF THE INVENTION

1. Field of the Invention

The present invention relates to a pair of snips and, particularly, to the pair of snips with a lock device which is one-hand-operable.

2. Description of the Related Art

Referring to TW patent No. 1389780, a pair of shears includes a first cutting member, a second cutting member pivotally connecting to the first cutting member about a first pivot, a first handle connecting to the first cutting member, a second handle connecting to the second cutting member and pivotally connecting to the first handle about a second pivot, and a spring supported by the second pivot and including a first leg abutting the first cutting member and a second leg abutting the second cutting member, respectively. Moreover, the pair of shears is adapted to be locked. When the pair of shears is locked, tip ends of the first and second cutting members as well as first and second handles are prevented from moving away from one another. The lock device includes a first distal end pivotally connecting to a first fastener mounted on the second handle and a second distal end releasably and selectively catching a second fastener mounted on the first handle, respectively. When the second distal end of the lock device catches the second fastener, the shears is locked. The lock device is pivotal counterclockwise about the first fastener to catch the second fastener. However, a user can not lock the shears with one hand easily. When the user grips the first and second handles, the thumb-index web space and the palm of the right hand rest on the first handle and are stopped by a lower side of a first hand stop, which protrudes transversely from the first handle and, in addition, the fingers of the right hand rest on the second handle, with the index finger holding on an upper side and other fingers holding on a lower side of a second hand stop, which protrudes transversely from the second handle. Therefore, it is difficult for the user to grip the first and second handles while moving the lock device counterclockwise to reach and catch the second fastener with one hand.

The present invention is, therefore, intended to obviate or at least alleviate the problems encountered in the prior art.

### SUMMARY OF THE INVENTION

According to the present invention, a pair of snips with one-hand-operable lock device includes a first and second grip disposed side by side, a pair of cutting members pivotally connecting with each other and including one cutting member connecting to the first grip and the other cutting member connecting to the second grip respectively, and a lock device including a structural member pivotally connecting to the first grip and including a first structural section as a user control end disposed at one of two opposite ends of the structural member, a second structural section as a locking end disposed at the other end of the structural member, and a third structural section disposed between the first and second structural sections and including a pivot extending therefrom and engaging with the first grip.

The pair of snips is locked and is in a locked position thereof in which the second structural section of the structural member is restrained on the other of the first and second grips and tip ends of the pair of cutting members are prevented from moving away from each other.

The pair of snips is unlocked and in a unlock position thereof in which the second structural section of the structural member is released from the other of the first and second grips and the tip ends of the pair of cutting members are pivotal away from each other.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure. The abstract is neither intended to define the invention, which is measured by the claims, nor is it intended to be limiting as to the scope of the invention in any way.

It is therefore an object of the present invention to provide a pair of snips with a lock device which is one-hand-operable and which is adapted to lock the pair of snips.

Other objectives, advantages, and new features of the present invention will become apparent from the following detailed description of the invention when considered in conjunction with the accompanied drawings.

### BRIEF DESCRIPTION OF THE DRAWINGS

FIG. 1 is a perspective view of a pair of snips with a one-hand-operable lock device in accordance with the present invention and shows the pair of snips being locked by the lock device.

FIG. 2 is a partial, exploded perspective view of the pair of snips of the present invention.

FIG. 3 is a cross-sectional view taken along line 3-3 of FIG. 1.

FIG. 4 is a cross-sectional view taken along line 4-4 of FIG. 1.

FIG. 5 illustrates the operation of unlocking the pair of snips of the present invention and that includes the lock device automatically unlocking the pair of snips upon gripping grips of the pair of snips towards each other.

FIG. 6 is an extended view of FIG. 5 showing the pair of snips being unlocked and in one of open positions thereof.

FIG. 7 illustrates the operation of locking the pair of snips of the present invention and that includes the lock device is one-hand-operable.

### DETAILED DESCRIPTION OF THE INVENTION

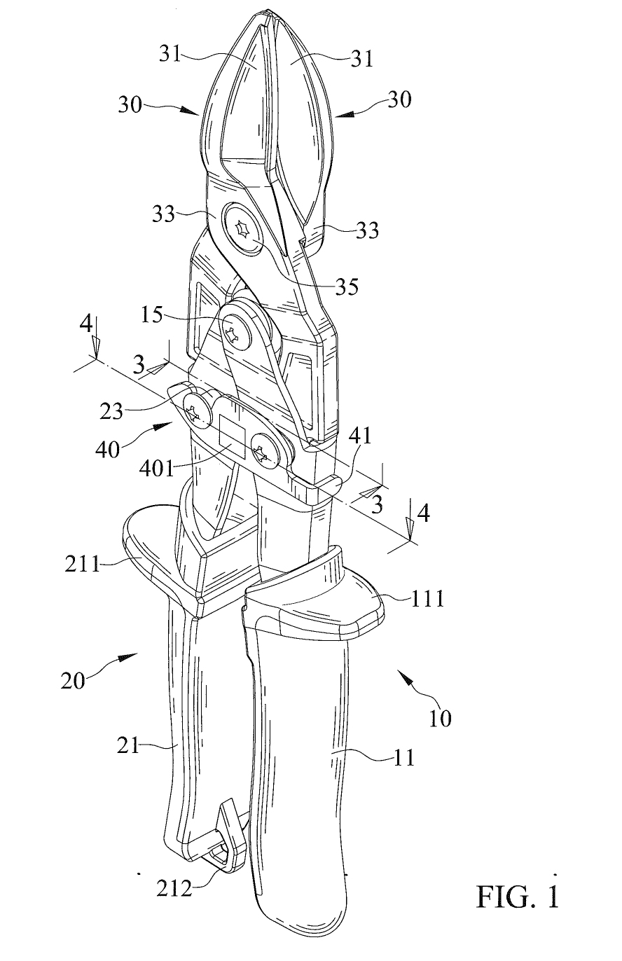

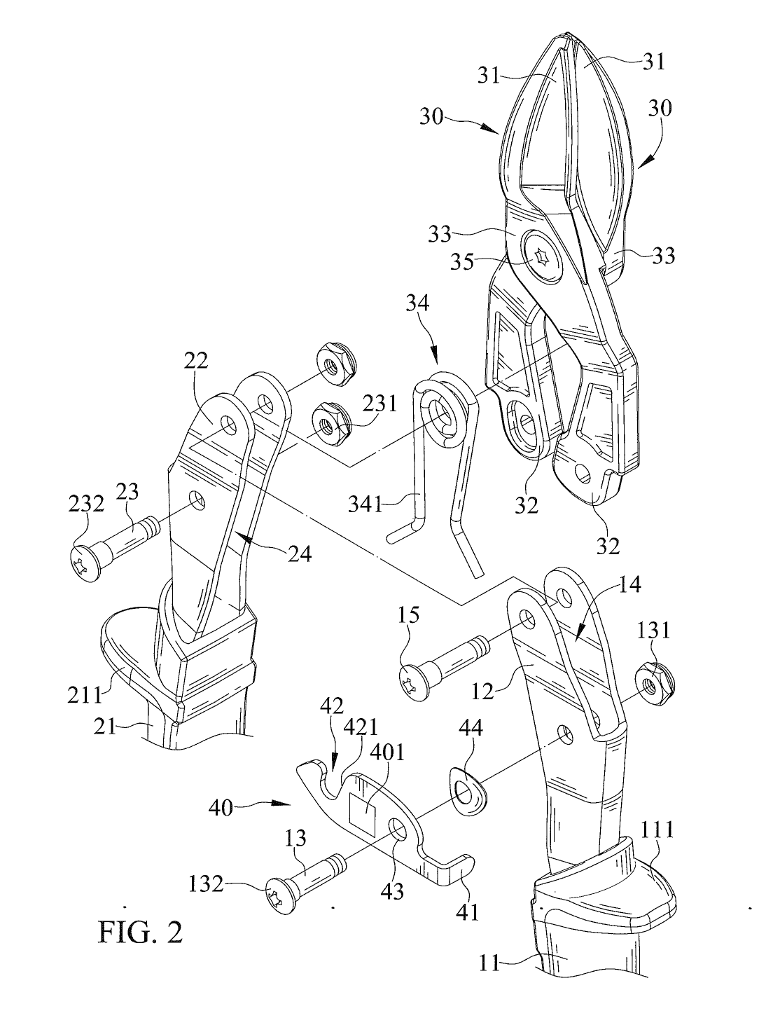

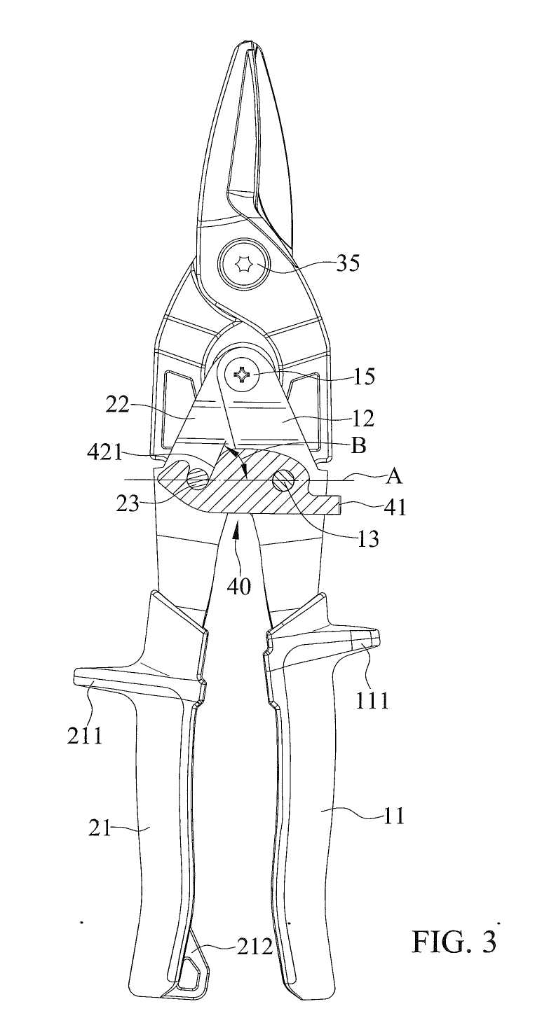

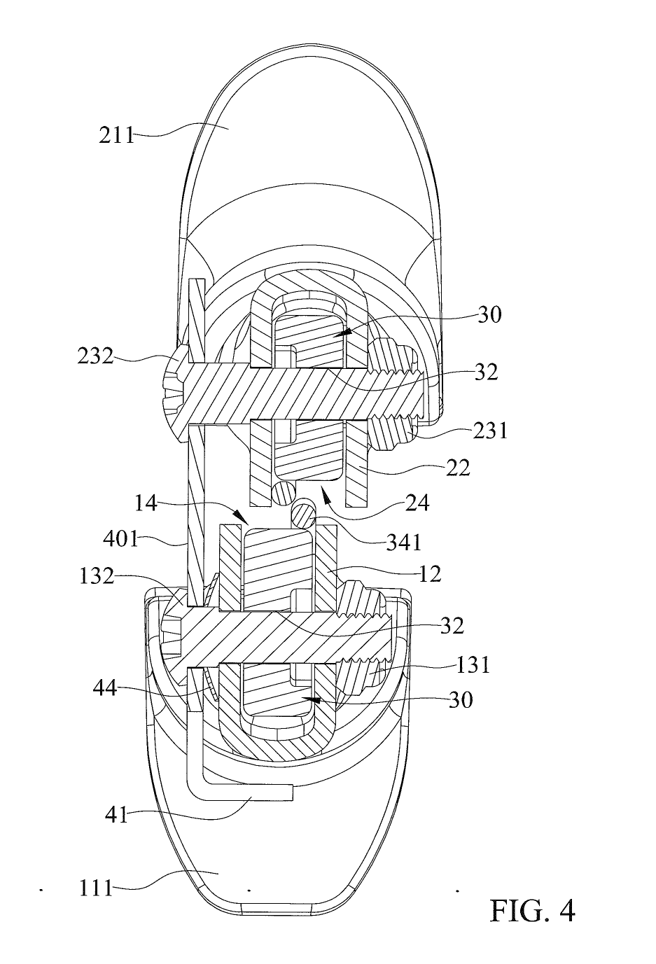

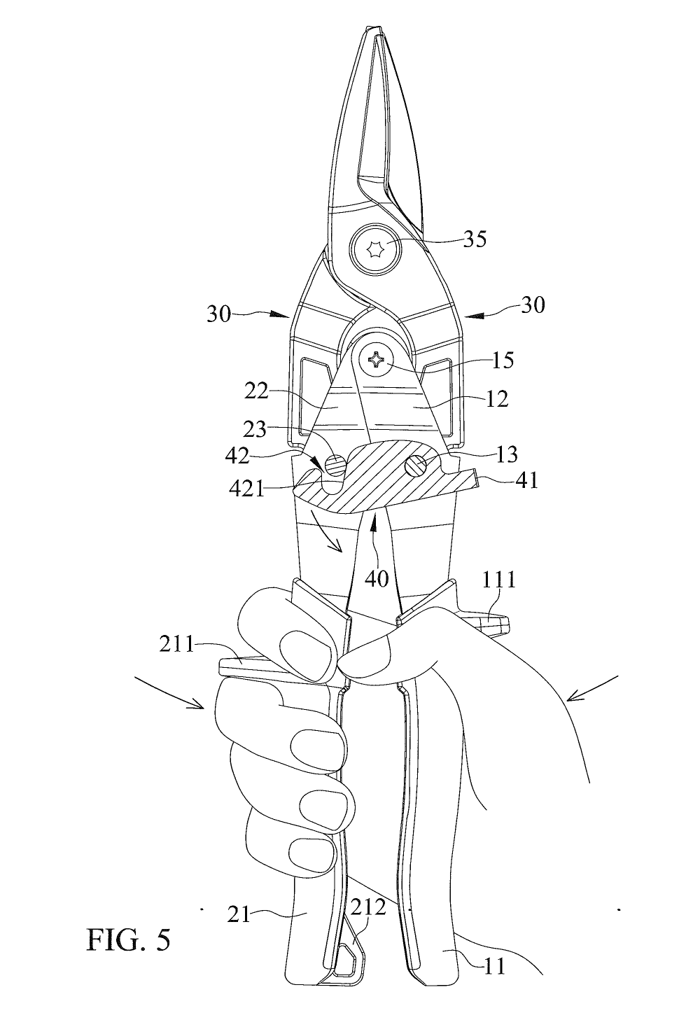

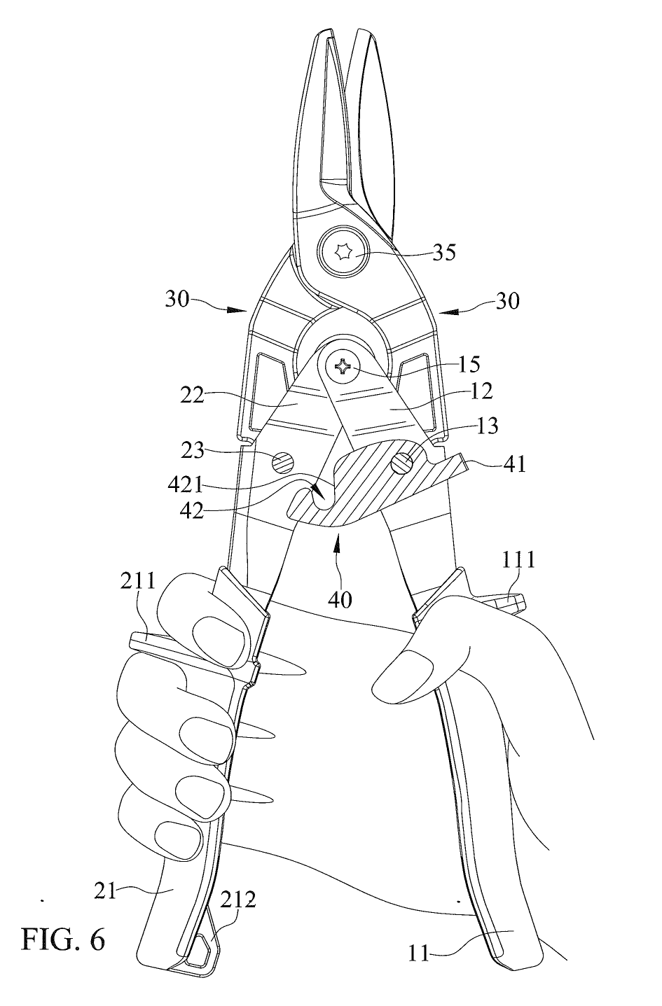

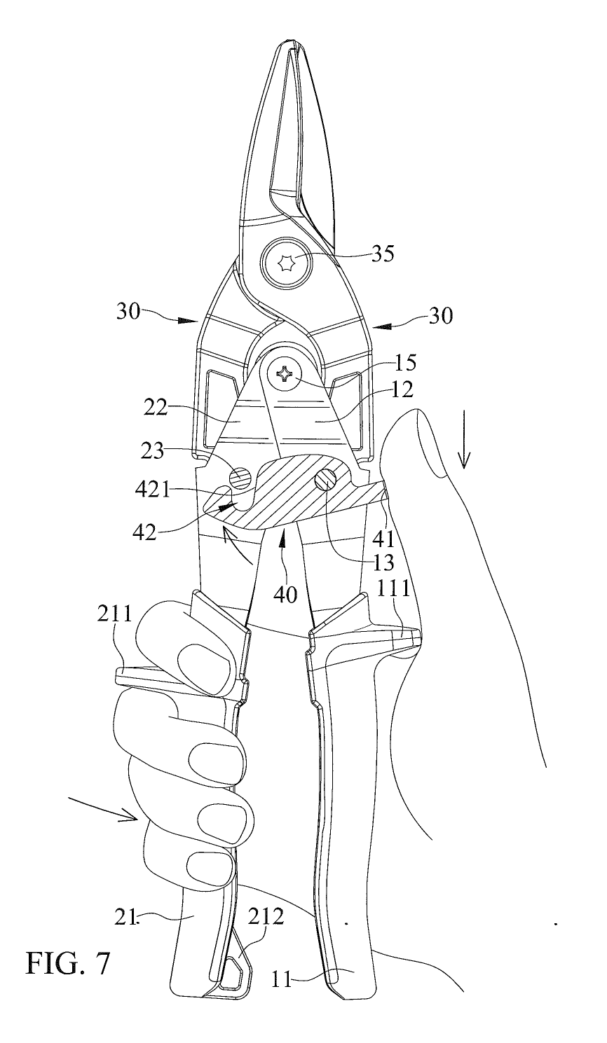

FIGS. 1 through 7 show a pair of snips with a one-hand-operable lock device in accordance with the present invention. The pair of snips includes a first and second grip 10 and 20, a pair of cutting members 30 and a lock device 40.

Each of the first and second grips 10 and 20 includes a first end thereof allowing a user to ergonomically grip and a second end thereof connecting to one of the pair of cutting members 30. The first and second snips 10 and 20 are disposed side by side. The first and second grips 10 and 20 are interconnected by a fastener 15. The first and second grips 10 and 20 are pivotal with respect to one another about the fastener 15. Each of the first and second grips 10 and 20 has a body 12 and 22 including two first walls disposed oppositely and in a spaced relationship and a second wall interconnecting and extend between the first walls. The first end of the first grip 10 is sheathed with a first grip cover 11 which further provides for a comfortable grip of the first grip 10. The first end of the second grip 20 is sheathed with a second grip cover 21 which further provides for a comfortable grip of the second grip 20. At least one of the first and second grip covers 11 and 21 includes an outer lateral edge thereof including a hand stop 111 and 211 protruding therefrom and transversely to a longitudinal direction of one of the first and second grip covers 11 and 21. The first grip cover 11 includes an outer lateral edge thereof including a first hand stop 111 protruding therefrom transversely. The second grip cover 21 includes an outer lateral edge thereof protruding therefrom transversely. The first and second hand stops 111 and 211 protrude unsymmetrically and at different levels. The pair of snips includes at least one hanging end 212. Therefore, the pair of snips can be hung. In the embodiment of the present invention, the hanging end is designed with a hang hole. The at least one hanging end 212 may protrudes from one of the first and second grips 10 and 20. In the embodiment of the present invention, the second grip cover 21 includes the at least one hanging end 212.

The pair of cutting members 30 pivotally connects with each other and includes one cutting member 30 connecting to the first grip 10 and the other cutting member 30 connecting to the second grip 20, respectively. The first grip 10 and the cutting member 30 connected thereto are interconnected by a first fastening assembly. The second grip 20 and the cutting member 30 connected thereto are interconnected by a second fastening assembly. The first grip 10 and the cutting member connected thereto are pivotal with respect to one another about the first fastening assembly. The second grip 20 and the cutting member connected thereto are pivotal with respect to one another about the second fastening assembly. Each of the pair of cutting members 30 has a first distal end 31 forming a blade, a second distal end 32 connecting to one of the first and second grips 10 and 20, and a middle 33 between the first and second distal ends. Each of the pair of cutting members 30 includes the second distal end thereof disposed in a gap 14 and 24 between the two first walls of the body of the grip 10 and 20 connected thereto. The pair of cutting members 30 is interconnected by a fulcrum 35. The pair of cutting member 30 is pivotal with respect to one another about the fulcrum 35. Each of the pair of cutting members 30 has a through hole and the fulcrum 35 is received in the through holes of the cutting members 30. Each of the pair of cutting members 30 includes the through hole extending through the middle 33 thereof. The fulcrum 35 is disposed on the middle of each of the pair of cutting members.

The first and second grips 10 and 20 include a biasing member 34 engaging therebetween. The biasing member 34 is mounted on the fastener 15. The biasing member 34 includes at least one loop receiving the fastener and two legs 341 respectively abutting the two first and second grips 10 and 20 and counteracting a grip force of the pair of snips applied thereto. The fastener 15 inserts through the at least one loop of the biasing member. Therefore, the biasing member 34 is supported by the fastener 15. The first and second grips 10 and 20 each have a through hole that receives the 24 fastener 15. The biasing member 34 is disposed in a gap between the two first walls of the body of each of the first and second grips 10 and 20 and is protected and constrained by the first and second grips 10 and 20.

The lock device 40 includes a structural member pivotally connecting to the first grip 10 and including a first structural section 41 as a user control end disposed at one of two opposite ends of the structural member, a second structural section 42 as a locking end disposed at the other end of the structural member, and a third structural section 43 disposed between the first and second structural sections 41 and 42 and including a pivot extending therefrom and engaging with the first grip 10. The structural member of the lock device 40 is a one piece construction. The first, second and third structural sections 41 and 42 are formed integrally on two opposite ends of the structural member. The structural member is in a form of a plate.

The pair of snips is locked and is in a locked position thereof in which the second structural section 42 of the structural member is restrained on the second grip 20 and tip ends of the pair of cutting members are prevented from moving away from each other.

The pair of snips is unlocked and in a unlock position thereof in which the second structural section 42 of the structural member is released from the second grip 20 and the tip ends of the pair of cutting members are pivotal away from each other.

The first structural section 41 includes a distal end having a length extending transversely to a longitudinal direction of the pair of snips and disposed away from the first grip 10. Therefore, a user is able to operably pivot the structural member of the lock device 40 from the distal end of the first structural section that is disposed away from the one of the first and second grips 10 and 20. In this embodiment, the first structural section 41 includes the length thereof forming an L-shaped projection, with one of two extensions of the L-shaped projection offsetting from the first grip 10.

The second structural section 42 forms a recess and the second grip 20 includes a latching structure protruding therefrom releasably engaging with the recess. The recess has a top forming an open end, a bottom forming a closed end and two lateral edges extending divergently with from the bottom to the top. The recess includes one of the lateral edges as a guiding edge 421 for the latching structure. The guiding edge forms a slope and disposed between the latching structure and the pivot. The lateral edge of the recess which defines the guiding edge 421 is more adjacent to the first structural section 41 of the structural member than the other lateral edge.

The latching structure assembly engages in the recess when the pair of snip is in the lock position thereof. The latching structure disengages from the recess when the pair of snips is in the unlock position thereof.

The pivot and the latching structure are aligned with a first line A. The guiding edge 421 extends along a second line B which inclines from the first line at an angle which is less than 90 degrees and is between the pivot and the latching structure. The recess is designed with a contour that can allow a user to automatically unlock the pair of snips upon gripping grips of the pair of snips towards each other.

The first fastening assembly includes a first axle 13 defining the pivot extending from the third structural section 43 of the structural member of the lock device 40. The second fastening assembly includes a second axle 23 defining the latching structure and releasably engaging with the recess 42.

The first fastening assembly includes a first restrainer 131 engaging with and preventing the first axle 13 from disengaging from the first grip 10 and the cutting member 30 connected thereto. The second fastening assembly includes a second restrainer 231 engaging therewith and preventing the second axle 23 from disengaging from the second grip 20 and the cutting member 30 connected thereto. Each of the first and second axles 13 and 23 and the respective first and second restrainers 131 and 231 are in thread engagement. The first grip 10, the cutting member 30 connected to the first grip 10, and the third structural section 43 of the structural member of the lock device 40 each include a hole extending therethrough. The first axle 13 interconnects the first grip 10, the cutting member 30 connected to the first grip 10, and the third structural section 43 of the structural member and the first restrainer 131 by inserting through the holes of the first grip 10, the cutting member 30 connected to the first grip 10, and the third structural section 43 of the structural member to and fastens with the first restrainer 131. The second grip 20 and the cutting member 30 connected thereto each include a hole extending therethrough. The second axle 23 interconnects the second grip 20, the cutting member 30 connected to the second grip 20, and the second restrainer 231 by inserting through the holes of the second grip 20 and the cutting member 30 connected thereto and fastens with the second restrainer 231.

The first axle 13 has an enlarged distal end 132 of a size greater than the holes of the first grip 10, the cutting member 30 connected to the first grip 10, and the structural member of the lock device 40. The enlarged distal end of the first axle 13 and the first restrainer 131 are disposed on two opposite sides of an outer periphery of the first grip 10. The second axle 23 has an enlarged distal end 232 of a size greater than the holes of the second grip 20. The enlarged distal end of the second axle 23 and the second restrainer 231 are disposed on two opposite sides of an outer periphery of the second grip 20.

In view of the foregoing, when the user grips the first and second grips 10 and 20 to operate the pair of snips, the thumb-index web space and the palm of the right hand rest on the first grip 10 and are stopped by a lower side of the first hand stop 111, which protrudes transversely from the first grip cover 11 and, in addition, the fingers of the right hand rest on the second grip 20, with the index finger holding on an upper side and other fingers holding on a lower side of the second hand stop 211, which protrudes transversely from the second grip cover 21. The first and second hand stops 111 and 211 protrude unsymmetrically and at different levels. The first hand stop 111 is at a relative higher position than the second hand stop 211. The user can operate the pair of snips ergonomically and effectively.

In order to not only lock the pair of snips with one hand ergonomically without losing the grip on the pair of snips, but also to avoid interference with the structure of one of the first and second grips 10 and 20, the user operably pivots the structural member of lock device 40 from the distal end of the first structural section that is disposed away from the one of the first and second grips 10 and 20.

Furthermore, the first fastening assembly includes a spring washer 44 mounted on the first axle 13 and facilitating pivoting of the structural member of the lock device 40. The first axle 13 inserts through the spring washer 44 through a hole which extends through the spring washer 44. The spring washer 44 is disposed between the third structural section 43 of the structural member of the lock device 40 and the outer periphery of the first grip 10.

The foregoing is merely illustrative of the principles of this invention and various modifications can be made by those skilled in the art without departing from the scope and spirit of the invention.

What is claimed is:

1. A pair of snips with one-hand-operable lock device comprising:
a first and second grip disposed side by side;
a pair of cutting members pivotally connecting with each other and including one cutting member connecting to the first grip and the other cutting member connecting to the second grip, respectively; and
a lock device including a structural member pivotally connecting to the first grip and including a first structural section as a user control end disposed at one of two opposite ends of the structural member, a second structural section as a locking end disposed at the other end of the structural member, and a third structural section disposed between the first and second structural sections and including a pivot extending therefrom and engaging with the first grip;
wherein the pair of snips is locked and is in a locked position thereof in which the second structural section of the structural member is restrained on the second grip and tip ends of the pair of cutting members are prevented from moving away from each other; and
wherein the pair of snips is unlocked and in a unlock position thereof in which the second structural section of the structural member is released from the second grip and the tip ends of the pair of cutting members are pivotal away from each other.

2. The pair of snips with one-hand-operable lock device as claimed in claim 1, wherein the first structural section includes a distal end having a length extending transversely to a longitudinal direction of the pair of snips and disposed away from the first grip.

3. The pair of snips with one-hand-operable lock device as claimed in claim 2, wherein the first structural section includes the length thereof forming an L-shaped projection, with one of two extensions of the L-shaped projection offsetting from one of the first grip.

4. The pair of snips with one-hand-operable lock device as claimed in claim 1, wherein the second structural section forms a recess and the second grip includes a latching structure protruding therefrom releasably engaging with the recess, wherein the latching structure assembly engages in the recess when the pair of snip is in the lock position thereof, and wherein the latching structure disengages from the recess when the pair of snips is in the unlock position thereof.

5. The pair of snips with one-hand-operable lock device as claimed in claim 4, wherein the recess has a top forming an open end, a bottom forming a closed end and two lateral edges extending divergently with from the bottom to the top, and wherein the recess includes one of the lateral edges as a guiding edge for the latching structure, with the guiding edge forming a slope and disposed between the latching structure and the pivot.

6. The pair of snips with one-hand-operable lock device as claimed in claim 5, wherein the pivot and the latching structure are aligned with a first line, and wherein the guiding edge extends along a second line which inclines from the first line at an angle which is less than 90 degrees and is between the pivot and the latching structure.

7. The pair of snips with one-hand-operable lock device as claimed in claim 4, wherein the first grip and the cutting member connected thereto are interconnected by a first fastening assembly, wherein the second grip and the cutting member connected thereto are interconnected by a second fastening assembly, wherein the first grip and the cutting member connected thereto are pivotal with respect to one another about the first fastening assembly, wherein the second grip and the cutting member connected thereto are pivotal with respect to one another about the second fastening assembly, wherein the first fastening assembly includes a first axle defining the pivot extending from the third structural section of the structural member of the lock device, and wherein the second fastening assembly includes a second axle defining the latching structure and releasably engaging with the recess.

8. The pair of snips with one-hand-operable lock device as claimed in claim 7, wherein the first fastening assembly includes a first restrainer engaging with and preventing the first axle from disengaging from the first grip and the cutting member connected thereto, and wherein the second fastening assembly includes a second restrainer engaging therewith and preventing the second axle from disengaging from the second grip and the cutting member connected thereto.

9. The pair of snips with one-hand-operable lock device as claimed in claim 8, wherein the first grip, the cutting member connected to the first grip, and the third structural section of the structural member of the lock device each include a hole extending therethrough, wherein the first axle interconnects the first grip, the cutting member connected to the first grip, and the third structural section of the structural member and the first restrainer by inserting through the holes of the first grip, the cutting member connected to the first grip, and the third structural section of the structural member to and fastens with the first restrainer, wherein the second grip and the cutting member connected thereto each include a hole extending therethrough, and wherein the second axle interconnects the second grip, the cutting member connected to the second grip, and the second restrainer by inserting through the holes of the second grip and the cutting member connected thereto and fastens with the second restrainer.

10. The pair of snips with one-hand-operable lock device as claimed in claim 9, wherein the first axle has an enlarged distal end of a size greater than the holes of the first grip, the cutting member connected to the first grip, and the structural member of the lock device, and wherein the enlarged distal end of the first axle and the first restrainer are disposed on two opposite sides of an outer periphery of the first grip.

11. The pair of snips with one-hand-operable lock device as claimed in claim 10, wherein the second axle has an enlarged distal end of a size greater than the holes of the second grip, and wherein the enlarged distal end of the second axle and the second restrainer are disposed on two opposite sides of an outer periphery of the second grip.

12. The pair of snips with one-hand-operable lock device as claimed in claim 7, wherein the first fastening assembly includes a spring washer mounted on the first axle and facilitating pivoting of the structural member of the lock device, with the first axle inserting through the spring washer through a hole which extends through the spring washer.

13. The pair of snips with one-hand-operable lock device as claimed in claim 1, wherein each of the pair of cutting members has a first distal end forming a blade, a second distal end connecting to one of the first and second grips, and a middle between the first and second distal ends, wherein the pair of cutting members is interconnected by a fulcrum, wherein the pair of cutting member is pivotal with respect to one another about the fulcrum, and wherein the fulcrum is disposed on the middle of each of the pair of cutting members.

14. The pair of snips with one-hand-operable lock device as claimed in claim 1, wherein the first and second grips are interconnected by a fastener, wherein the first and second grips are pivotal with respect to one another about the fastener, wherein the first and second grips include a biasing member engaging therebetween, wherein the biasing member is mounted on the fastener, and wherein the biasing member includes at least one loop receiving the fastener and two legs respectively abutting the two first and second grips and counteracting a grip force of the pair of snips applied thereto.

15. The pair of snips with one-hand-operable lock device as claimed in claim 13, wherein each of the first and second grips has a body including two first walls disposed oppositely and in a spaced relationship and a second wall interconnecting and extend between the first walls, wherein each of the pair of cutting members includes the second distal end thereof disposed in a gap between the two first walls of the body of the grip connected thereto.

16. The pair of snips with one-hand-operable lock device as claimed in claim 15, wherein the biasing member is disposed in a gap between the two first walls of the body of each of the first and second grips and is protected and constrained by the first and second grips.

17. The pair of snips with one-hand-operable lock device as claimed in claim 1, wherein each of the first and second grips includes a first end thereof allowing a user to ergonomically grip and a second end thereof connecting to one of the pair of cutting members, wherein the first end of the first grip is sheathed with a first grip cover which further provides for a comfortable grip of the first grip, wherein the first end of the second grip is sheathed with a second grip cover which further provides for a comfortable grip of the second grip, wherein at least one of the first and second grip covers includes an outer lateral edge thereof including a hand stop protruding therefrom and transversely to a longitudinal direction of one of the first and second grip covers.

18. The pair of snips with one-hand-operable lock device as claimed in claim 17, wherein the first grip cover includes an outer lateral edge thereof including a first hand stop protruding therefrom transversely, and wherein the second grip cover includes an outer lateral edge thereof protruding therefrom transversely.

19. The pair of snips with one-hand-operable lock device as claimed in claim 18, wherein the first and second hand stops protrude unsymmetrically and at different levels.

20. The pair of snips with one-hand-operable lock device as claimed in claim 1, wherein the structural member of the lock device is a one piece construction, and wherein the first, second and third structural sections are formed integrally on two opposite ends of the structural member.
